(19) United States
(12) Patent Application Publication
(10) Pub. No.: US 2012/0266091 A1
(43) Pub. Date: Oct. 18, 2012

(54) METHOD AND APPARATUS FOR REPRESENTING USER DEVICE AND SERVICE AS SOCIAL OBJECTS

(75) Inventors: Jeong-beom KIM, Suwon-si (KR); Su-hyun NAM, Suwon-si (KR); Ho-jung LEE, Seoul (KR)

(73) Assignee: SAMSUNG ELECTRONICS CO., LTD., Suwon-si (KR)

(21) Appl. No.: 13/297,961

(22) Filed: Nov. 16, 2011

(30) Foreign Application Priority Data
Apr. 12, 2011 (KR) 10-2011-0033771

(51) Int. Cl. G06F 3/00

(52) U.S. Cl. 715/760

(57) ABSTRACT

A method and apparatus for representing a user device and a service as social objects include: registering user information; receiving social Web service account information of the user from a social Web service, and registering the social Web service account information in relation to the user information; and receiving information about the user device and information about services executed in the user device, and registering the received information in relation to the user information.

### CROSS-REFERENCE TO RELATED PATENT APPLICATION

This application claims the benefit of Korean Patent Application No. 10-2011-0033771, filed on Apr. 12, 2011, in the Korean Intellectual Property Office, the disclosure of which is incorporated herein in its entirety by reference.

### BACKGROUND

1. Field

The inventive concept relates to a method and apparatus for representing a user device and service as social objects, and more particularly, to a method and apparatus for representing a user device and service as social objects based on an external social relationship.

2. Description of the Related Art

A number of factors have given rise to device to device (D2D) convergence technologies: the availability of various wireless networks, increases in wireless network coverage, a reduction in the price of communication modules, and the suggestion of various sensor technologies. D2D convergence technology is a communication technology for transmitting data between devices in a wired or wireless network without human interaction.

It is, however, difficult to satisfy the demand of users for an easy way to share content with other people by using the D2D convergence technology in a content-based approach; in addition, the services based on the experiences of other people might not be provided.

### SUMMARY

The exemplary embodiments include a method and apparatus for representing a user device and service as social object based on an external social relationship, and a computer readable recording medium having embodied thereon a program for executing the method.

According to another exemplary embodiment, there is provided a method of representing a user device and a service as a social object, the method including: registering user information; receiving social Web service account information of the user from a social Web service, and registering the social Web service account information in relation to the user information; and receiving information about the user device and information about services executed in the user device, and registering the received information in relation to the user information.

Relating between the social Web service account information of the user and the user information, and relating between the device information, the service information, and the user information may be performed by a binding information representing technology including at least one of resource description framework (RDF), extensible markup language (XML)-based metadata, and relational database.

The registering of the user information may include generating a person instance including a personal identity (ID) of the user based on a domain name service (DNS) registration information of the user.

The receiving of the social Web service account information of the user and the registration of the information in relation to the user information may include: generating a social Web service ID instance including social Web service ID of the user based on the social Web service account information; and binding the social Web service ID instance to the person instance.

The receiving of the user device information and the service information and the registration of the information in relation to the user information may include: receiving device information of the user; generating a device instance including the device information; and binding the person instance to the device instance by using a register instance.

The method may further include registering a storing location of the device instance, when the device instance is stored in a divided type.

The receiving of the user device information and the service information, and the registering of the information in relation to the user information may include: generating a service instance including information about a service to be shared; and binding the device instance to the service instance.

According to another exemplary embodiment, there is provided a method of representing a user device and a service as a social object. This includes accessing a social Web service account to receive and provide social information including a list of friends of the user. A list of devices of a friend selected from the friend list is provided. A list of services executed in the devices included in the device list is provided. A service selected from the service list is executed.

The providing of the list of devices of the selected friend and the list of services executed in that device may include: searching for a list of devices bound to the selected friend, and displaying the found device list. A list of services, and contents of the services bound to the selected device, are searched for. The found service list and contents are displayed.

The providing of the device list of the selected friend and the service list executed in the device included in the device list may include setting the device list and/or the service list to be shared between the selected friend and the user.

The receiving and providing of the social information may include: performing a user verification based on a personal identity (ID) of the user; checking whether the verified user has social Web service ID information; receiving social information of the verified user and social Web service IDs of the friends included in the friend list, by accessing the social Web service; and displaying the friend list based on the received social information.

The providing of the device list of the selected friend and the service list executed in the device included in the device list may include: checking whether the selected friend is another user that has a verified personal ID, based on the social Web service ID of the selected friend; searching for a register instance that is bound to a person instance, including the personal ID of the checked friend; and generating and displaying a device instance list bound to the register instance and a shared service instance list bound to the device instance list and the contents of the shared service instance.

The device in the device list may share its service contents wirelessly with other devices.

According to another exemplary embodiment, there is provided an apparatus for representing a user device and a service as a social object, the apparatus including: a social domain registration unit for registering user information, receiving a social Web service account of the user from a social Web service, and registering the social Web service account in relation to the user information; and a device domain registration unit for receiving device information of the user and service information executed in the device, and registering the device and service information in relation to the user information.

The social domain registration unit may include: a person registration unit generating a person instance including a personal identity (ID) of the user based on domain name service (DNS) registration information of the user; and a social Web service ID binder generating a social Web service ID instance including a social Web service ID of the user based on the social Web service account information, and binding the social Web service ID instance to the person instance.

The device domain registration unit may include: a device registration unit receiving device information of the user, and generating a device instance including the device information; and a device binder binding the person instance and the device instance to each other by using a register instance.

The device domain registration unit may include a device location server registering a storing location of the device instance when the device instance is stored in a divided type.

The device domain registration unit may include: a service registration unit generating a service instance including information about a service to be shared; and a service binder binding the device instance and the service instance to each other.

According to another exemplary embodiment, there is provided an apparatus for representing a user device and a service as a social object, the apparatus including: a social domain providing unit receiving and providing social information including a list of friends of a user by accessing a social Web service; a device domain providing unit providing a list of devices of a friend selected from the friend list and a list of services executed in the device included in the device list; and a service execution unit executing the service selected from the service list.

The device domain providing unit may include: a device finder searching for an list of devices bound to the friend selected in the friend list; a service finder searching for an list of shared services bound to a device selected in the device list and contents of the shared services; and a graphic unit displaying the device list, and the shared service list and the contents of the shared service.

According to another exemplary embodiment, there is provided a computer readable recording medium having embodied thereon a computer program for executing the above method.

### BRIEF DESCRIPTION OF THE DRAWINGS

The above and other features and advantages of the inventive concept will become more apparent by describing in detail exemplary embodiments thereof with reference to the attached drawings in which:

FIG. 1A is a diagram illustrating a list of devices of a user (ME), a list of activation services executed in the devices, and friend relationship of ME;

FIG. 1B is a schematic diagram illustrating a method of realizing a system representing user devices/services as social objects based on external social relationship;

FIG. 1C is a diagram showing an example of social information obtained from a social domain;

FIGS. 2A and 2B are diagrams illustrating a device to device (D2D) convergence technology based on contents in consumer electronics (CE) devices;

FIG. 3 is a flowchart illustrating a registration method for realizing a system representing user devices/services as social objects based on an external social relationship, according to an exemplary embodiment;

FIGS. 4A and 4B are diagrams showing examples of class models used in each of processes of the system representing user devices/services as social objects based on an external social relationship, according to an exemplary embodiment;

FIGS. 5A through 5C are block diagrams schematically showing a registration device for realizing the system representing user devices/services as social objects based on an external social relationship, according to an exemplary embodiment;

FIG. 6 is a flowchart illustrating a discovery and sharing method for realizing the system representing user devices/services as social objects based on an external social relationship, according to an exemplary embodiment;

FIGS. 7A and 7B are block diagrams showing a discovery and sharing apparatus for realizing the system representing user devices/services as social objects based on an external social relationship, according to an exemplary embodiment;

FIG. 8 is a block diagram schematically showing a system representing user devices/services as social objects based on an external social relationship, according to an exemplary embodiment;

FIG. 9 is a diagram illustrating a process of generating a personal instance;

FIG. 10 is a diagram illustrating a process of generating a social Web service identification (ID) instance;

FIG. 11 is a diagram illustrating a process of generating a device instance;

FIG. 12 is a diagram illustrating a process of generating an active service instance;

FIG. 13 is a diagram illustrating processes of discovering and sharing user devices/service list based on an external social relationship;

FIG. 14 is a diagram illustrating a process of executing a service in a client, succeeded to the process of FIG. 13;

FIG. 15 is a diagram showing an example of a user interface screen according to a scenario according to an exemplary embodiment;

FIG. 16 is a block diagram of a system representing user devices/services as social objects based on an external social relationship according to a scenario according to an exemplary embodiment; and

FIG. 17 is a block diagram of a system representing user devices/services as social objects based on an external social relationship, according to another scenario.

### DETAILED DESCRIPTION

The inventive concept will now be described more fully with reference to the accompanying drawings, in which exemplary embodiments are shown. The inventive concept may, however, be embodied in many different forms and should not be construed as being limited to the embodiments set forth herein; rather, these exemplary embodiments are provided so that this disclosure will be thorough and complete, and will fully convey the concept to those skilled in the art.

Hereinafter, like reference numerals in the drawings denote like elements.

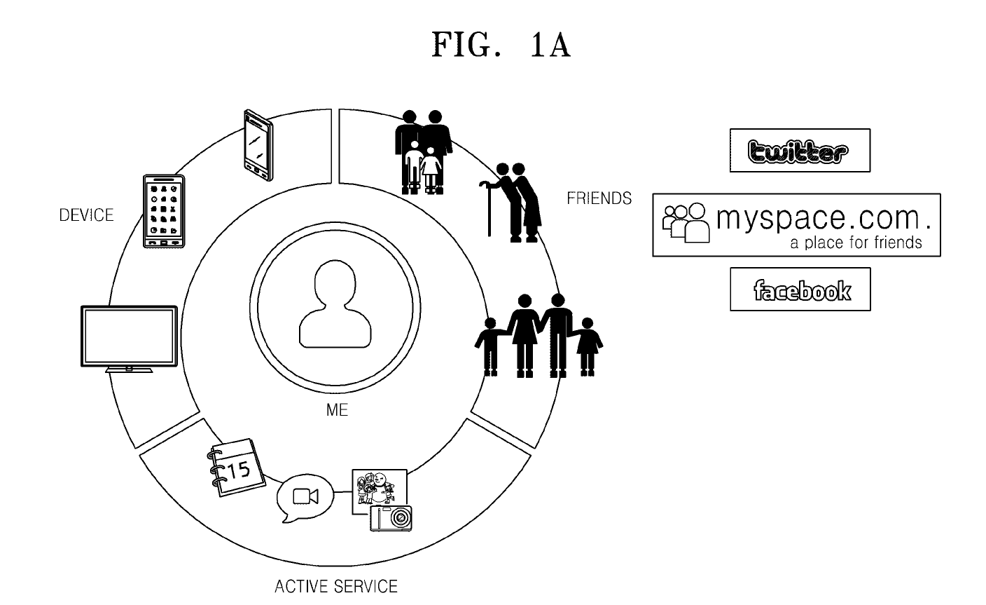

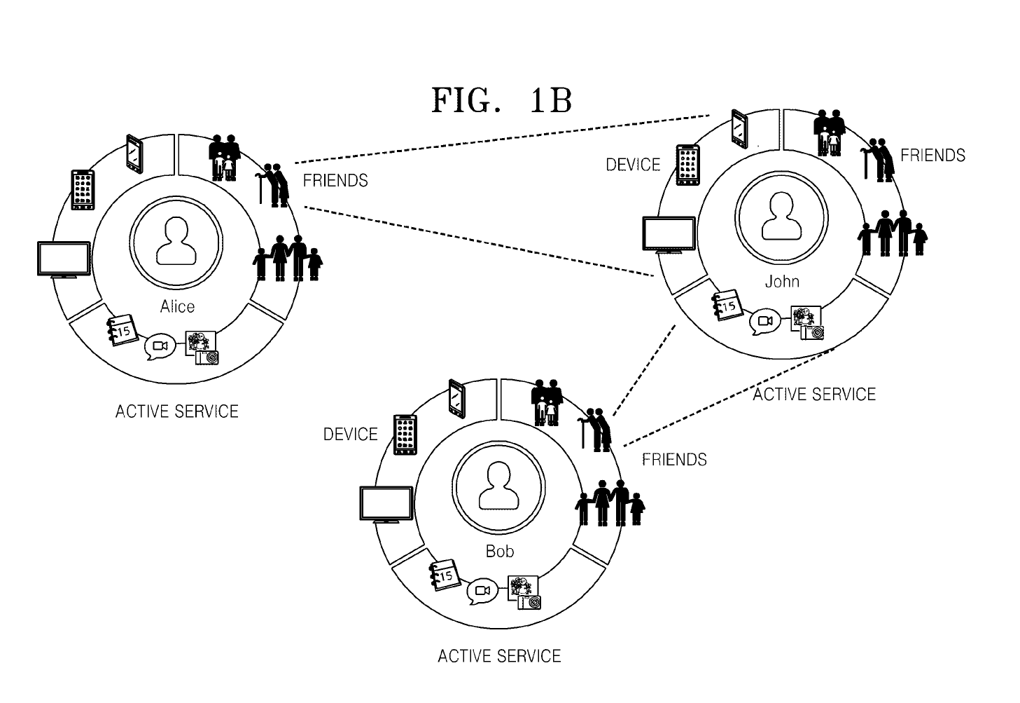

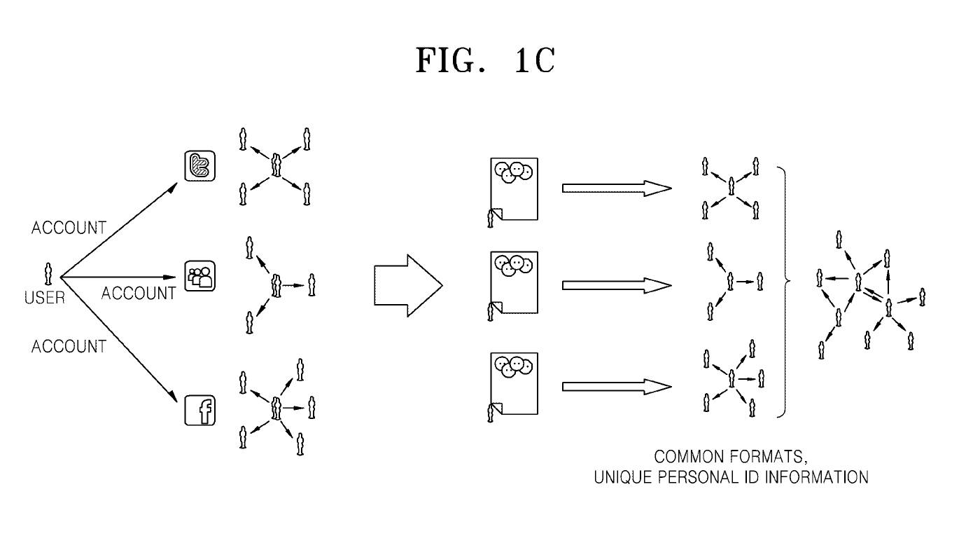

An overall framework for understanding the exemplary embodiments will be briefly described with reference to FIGS. 1A and 1B.

FIG. 1A shows a list of devices of a user (ME), a list of activation services executed in the user devices, and the friend relationships of ME.

The list of devices according to an exemplary embodiment may include all kinds of consumer electronics (CE) devices, for example, a digital video disc (DVD) player, a cellular phone, a computer, an MP3 player, a personal digital assistant (PDA), and a TV.

Each of the devices included in the device list allow a user to seamlessly use a device to device (D2D) convergence technology and activate the usage of services. The D2D convergence technology may open various technologies based on and depending on the device, and thus, create an experience space based on the device.

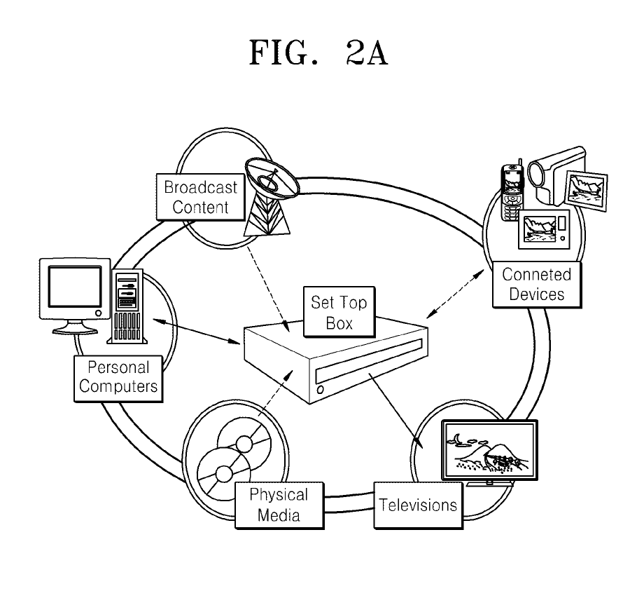

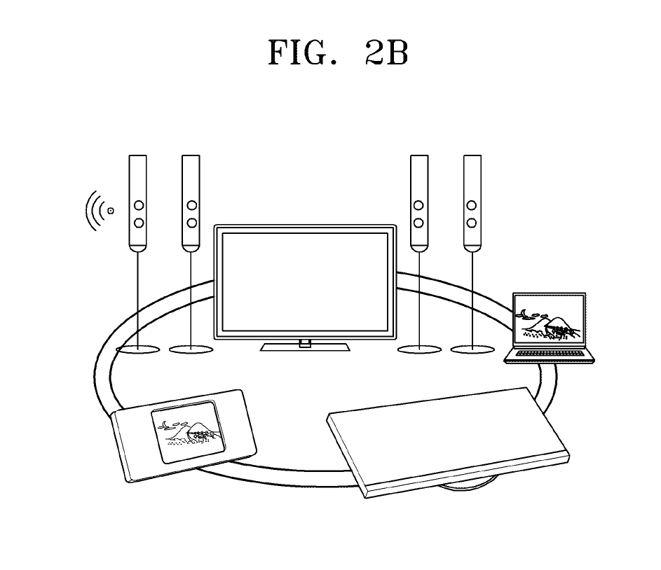

In addition, FIGS. 2A and 2B show a representative example of the D2D convergence technology based on the contents in the CE device. FIG. 2A illustrates an indirect D2D sharing by a controller (home gateway/set-top box (STB) setting), and FIG. 2B illustrates a direct D2D sharing between devices by using a certain protocol.

ALLSHARE and DLNA are examples of the D2D convergence technologies. However, the D2D convergence technologies considered herein are not limited to the above examples; various other D2D convergence technologies will commend themselves to those familiar with this field.

Referring back to FIG. 1A, the list of services according to the present exemplary embodiment may include all of the services executed in each of the devices included in the device list.

For example, the services of the TV may include an image viewer, a movie player, and a YOUTUBE player. In addition, the services of the cellular phone may include a multi-media message service (MMS), a short message service (SMS), and a gallery viewer. However, the list of possible services is not limited to the above examples.

Moreover, friends according to the present exemplary embodiment may include all persons relating to the user through any social Web service. Here, the term, “social Web service” may refer to a service for forming relationships between and among persons, and transmitting information such as updates in cyber space. Representative examples of the social Web services may include FACEBOOK, MYSPACE, NPLUGS, ME2DAY, TWITTER, etc.; however, the social Web services of the present exemplary embodiment are not limited to the above examples. In addition, herein, the term “social Web service” may also include a social networking service (SNS) and a social site.

The social Web service both collects and provides user data via an open application program interface (API) to create a Web-based experiential space. In addition, a number of social sites open the social information of users so as to create an experiential space, and thereby creating new social services and social commerce.

In addition, users of the social sites maintain and update the social information of their own and share their experiences with other users, based on the features of available on various CE devices.

In addition, social Web service providers make many efforts to create a space, in which the social Web service providers may exercise business influence over prospective consumers, i.e., the users of the social Web service. To this end, social Web service providers concentrate on overlaying marketing activity on top of relationships between persons.

The users of the social sites maintain and update the social information on their own, and want to share their experiences with others.

A main idea in many of the exemplary embodiments is to achieve following objectives in the environment shown in FIG. 1A for each user, under the assumption that the user (ME) wants to share their experience of using successive information that has overcome a spatial limitation with others.

A communication system between a social domain and a device domain, which may improve the applicability of D2D convergence services by using the social domain that provides users with an effective sharing channel, is suggested by diagramming a network between the users.

Here, the social domain may denote a plurality of social Web services (for example, TWITTER, FACEBOOK, etc.) representing social objects between the relationship between persons, and the device domain may denote a region (for example, ALLSHARE, DLNA, etc.) for defining technologies shared by the devices.

In addition, “social object” means a medium for allowing user socialization through a Web-based service. Examples of social objects may include MYSPACE—Music, YOUTUBE—online video, FLICKR—photo, DELICIOUS—bookmarks, tags, and blog-posts.

Also, an environment is provided to the user with device services based on the experiences of other people.

In addition, an environment is provided in which the user may share various information and services with friends or others by using a CE device.

FIG. 1B schematically illustrates a method of realizing a system representing the user device/service as the social objects based on an external social relationship.

Referring to FIG. 1B, Alice may share the services provided on her device with John by selecting one of John's devices. In addition, Bob may see on his device the services of the devices being shared by John.

At this time, advantages of using the social Web service for obtaining social information required to share the device services will be described with reference to FIG. 1C.

Referring to FIG. 1C, the user may have accounts in a plurality of social Web services in the social domain.

For example, it is assumed that the user (ME) has an identification (ID) Jane 11 in TWITTER domain, an ID Jane 22 in MYSPACE domain, and an ID Jane 33 in FACEBOOK domain.

Here, friends in different domains may be combined, and accordingly, a good deal of social information may be obtained. Moreover, according to the exemplary embodiments, common formats and unique personal ID are used in order to access the social domains.

In summary, in the exemplary embodiments, there is formed a social network as a set of devices and services, as well as relationships between people. In other words, the exemplary embodiments include representing the user device/service as the social object based on the external social relationship.

Using the approach described herein, according to various exemplary embodiments, the following problems of the conventional art may be overcome and/or ameliorated.

According to the conventional approach where D2D convergence technology is based on contents, it is difficult to satisfy the demand of a user for the easy sharing of contents with other people, and furthermore the conventional approach does not provide a service based on the experiences of other people.

In addition, a subject of a D2D convergence model is a relation between one device and another, and not a user. As a result, the data model used is one that involves machine readable data, and not human readable data. Thus, the user has to have substantial know-how.

In addition, the conventional social platform may provide a channel that may be somewhat effective in commercializing and merchandising products by diagramming the network between users; however, device optimization might not be possible because commercial content irrelevant to a user's target device are provided to that device.

Also, a D2D sharing technology uses mainly a virtual Internet protocol (IP) since the D2D sharing technology is generally used in a home network people do not normally have sufficient understanding about the D2D sharing technology. However, in the virtual IP, the user may not receive a call from other people, the user should adjust settings.

Lastly, a CE device-based SNS method is a method of providing services by each SNS in the CE device, and there is no way to provide own services of the device.

Hereinafter, a method of representing the user device/service as a social object, based on an external social relationship according to an exemplary embodiment will be described in more detail.

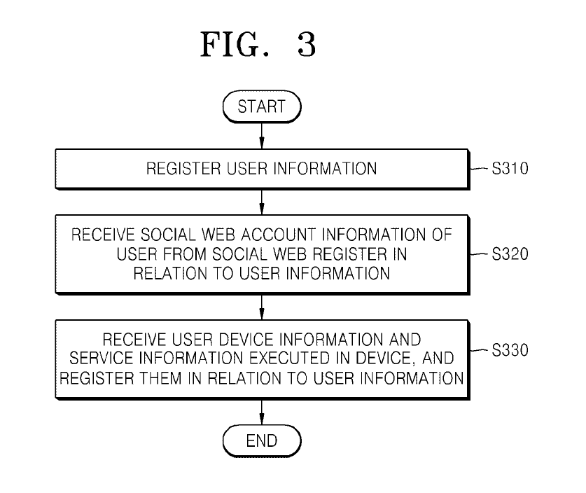

FIG. 3 is a flowchart illustrating a registration method for realizing a system representing the user device/service as the social object based on an external social relationship according to an exemplary embodiment.

In operation S310, user information is registered. That is, the registration means the generation of a personal account of the user after receiving user profile information through a certain client, so that the user may use the system. The client may, for example, be a Web client or a Web browser.

In more detail, a domain name service (DNS) of the user may be registered and a person instance of the user may be generated.

The person instance in the exemplary embodiment may be substituted by a person object and a person entity, and refers to an object including content relevant to the person. In this exemplary embodiment, the personal account includes at least personal ID information.

In operation S320, social Web service account information is received from a social Web service, and the received account information is stored in relation to the user information. In the present exemplary embodiment, the social Web service account information is obtained from an external social site, and may include at least social Web service ID information. For example, the social Web service account information may include a TWITTER account, a FACEBOOK account, or a MYSPACE account of the user.

A social Web service ID instance is generated by using the social Web service account information. In addition, the social Web service ID instance may be bound to the person instance. In the present exemplary embodiment, a technology for representing binding information may include the resource description framework (RDF), extensible markup language (XML)-based metadata, and/or relational databases. However, the inventive concept is not limited thereto, and various other technologies for representing the binding information will occur to those familiar with this field.

In operation S330, user device information and information about services executed in the user device are received, and then, the received information is registered in relation to the user information.

In more detail, according to the registration method, the user device information is received, and a device instance including the user device information may be generated.

Next, the person instance and the device instance are bound to each other by a register instance. That is, the register instance may include the person instance and the device instance and/or may indicate the correspondence between the person instance and the device instance.

On the other hand, if the generated one or more device instances are stored in divided spaces, the stored locations of the one or more device instances may be registered. The stored location may be a physical address such as an IP address or, e.g., a UDN (Unreal Developer Network) address of the device.

Next, a service instance including information about services to be shared may be generated. In addition, the device instance and the service instance may be bound to each other.

The registration method for realizing the system representing the user device/service as a social object based on an external social relationship will be described according to a scenario. However, the scenario is an example, and the application of the exemplary embodiments is not limited thereto.

1. The DNS information is registered by using the user profile information input through a Web browser, and the person instance of the user including the registered DNS information is generated.

2. A social Web service ID instance (Socialweb_id Instance) in which account information (uID) of a number of social Web services of the user is generated. Contents of bindProperty (person instance, Socialweb_id Instance) are stored in a data storage (not shown) through an RDF binder.

3. Device information is input from the user through the Web browser, and a device instance of the user is generated. Contents of bindProperty (person instance, Register instance) are stored in the data storage through the RDF binder. Also, contents of bindProperty (Register instance, Device Instance) are stored in the data storage through the RDF binder.

4. When an event of a service to be shared among the services of the device is generated, a shared service instance is generated.

Contents of bindProperty (Device instance, service instance) are stored in the data storage through the RDF binder.

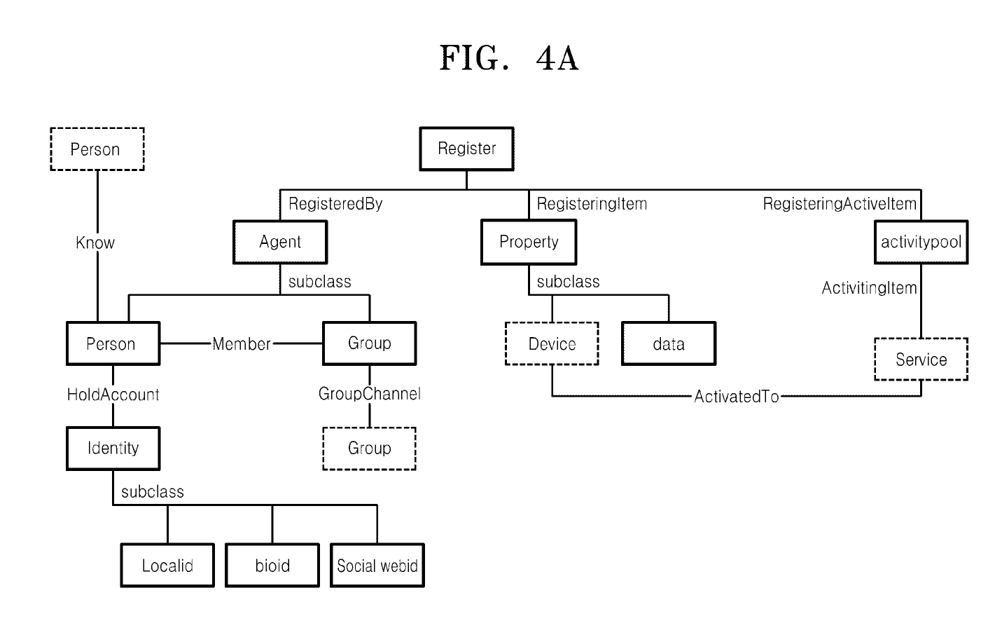

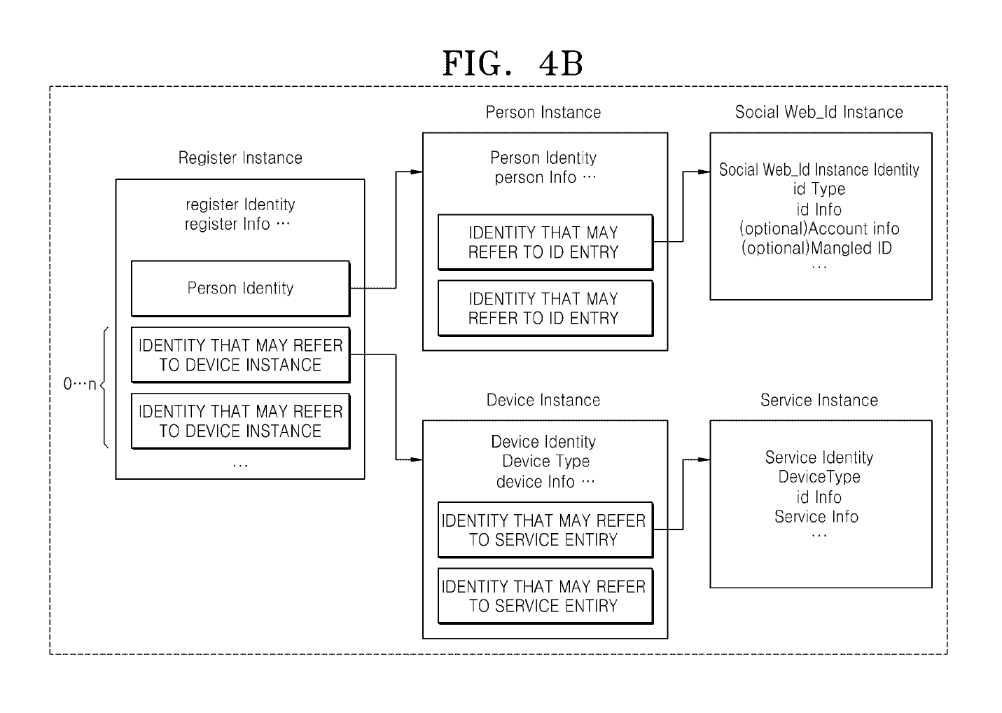

FIGS. 4A and 4B show examples of class models (that is, a structural view of instance relations), which may be implemented as part of a class library used in each of the processes of the system representing the user device/service as a social object based on the external social relationship. In each of the classes, when an instance is generated, the corresponding instance name is used. The technologies representing the binding information may include the RDF, the XML-based metadata, and the relational database, as described above.

Referring to FIG. 4A, the register instance includes the person instance and the device instance. In addition, the register instance has the person instance as the RegisteredBy property.

In more detail, referring to FIG. 4B, additional register information is inserted in the Register instance, and identities of one or more person instances and 0 or more device instances that may be referred to are inserted in the register instance.

Additional information about the person is added in the person instance, and the identity of 0 or more social Web service ID instances(Socialweb_id Instance) are expressed.

Additional information about the device is inserted in the device instance, and 0 or more service instance identities that may be referred to are expressed.

An ID type and additional information according to the type are input in the social Web service ID instance (SocialWeb_Id instance). The additional information may include domain and mangled ID of the social Web service; however, the inventive concept is not limited thereto.

Additional information about the services of the device are inserted in the service instance.

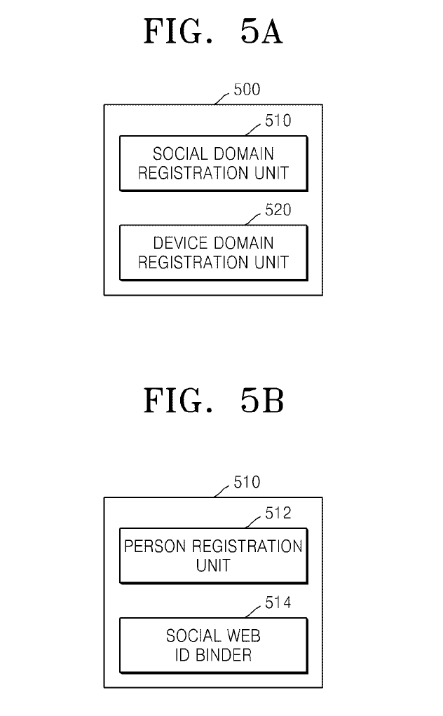

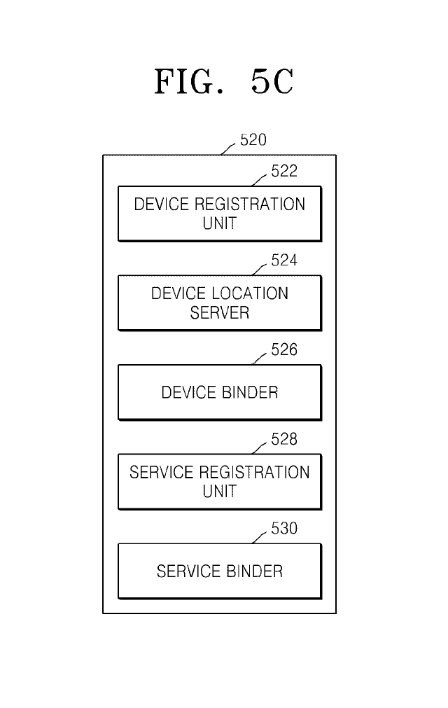

FIGS. 5A through 5C are block diagrams showing a registration device 500 for realizing the system representing the user device/service as a social object based on the external social relationship, according to an exemplary embodiment. In FIGS. 5A through 5C, each of the components may be formed as an independent chip, or two or more components may be formed as a single chip. The registration device 500 is a device for executing the registration method illustrated in FIG. 3, and will be described briefly as follows.

Referring to FIG. 5A, the registration device 500 includes a social domain registration unit 510 for registering user information, receiving user account information of the social Web service, and registering the user account information in relation to the user information, and a device domain registration unit 520 receiving user device information and information about the services executed in the device, and registering the received information in relation to the user information.

Referring to FIG. 5B, the social domain registration unit 510 includes a person registration unit 512 for generating the person instance including the ID of the user based on the DNS registration information of the user, and a social Web service ID binding unit 530 generating the social Web service ID instance including the social Web service ID of the user based on the social Web service account information of the user, and binding the social Web service ID instance to the person instance.

Referring to FIG. 5C, the device domain registration unit 520 includes a device registration unit 522, that receives the device information of the user and generates information including the device information, and a device binding unit 526, that binds the person instance and the device instance to each other by using the register instance.

Here, the device domain registration unit 520 may include a device location server unit 524 registering the stored location of the device instance when the device instance is stored in a dispersed form. In other words, when the device instance is stored in a dispersed manner, the stored locations of the device instances are registered in the device location server unit 524 so that a device discovery service may be executed based on the registration.

In addition, the device domain registration unit 520 may include a service registration unit 528, generating the service instance including information about the service to be shared, and a service binding unit 530, binding the device instance and the service instance to each other.

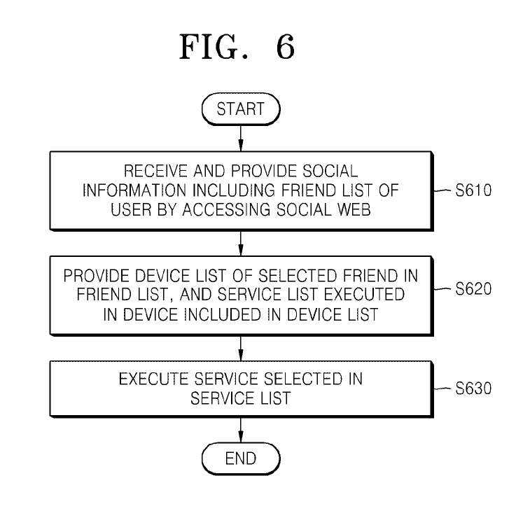

FIG. 6 is a flowchart illustrating a discovery and sharing method for realizing the system representing the user device/service as a social object based on the external social relationship, according to the exemplary embodiment. The discovery and sharing method illustrated in FIG. 6 corresponds to the registration method illustrated in FIG. 3. Thus, FIG. 6 will be described in relation to FIG. 3.

Referring to FIG. 6, in operation S610, social information including a list of friends of the user is received and provided by accessing the social Web service.

In more detail, the user logs in on the Web browser with their own personal ID, and is verified as a user. In addition, the discovery and sharing method searches for the social Web service ID instance bound to the person instance including the personal ID, and may access the social Web service by using the social Web service ID included in the searched social Web service ID instance or the social Web service account information.

Here, if the social Web service ID of the user is not bound to the person instance of the user, the user may be encouraged and/or invited to join the social Web service.

Next, according to the discovery and sharing method, the social information of the user and social Web service IDs of the friends of the user may be received. Then, the list of the friends may be displayed on the user's terminal.

In operation S620, a list of devices of the friends selected from the friend list, and a list of services available for execution in the devices of the device list are provided.

As an alternative, the discovery and sharing method may search for a list of devices bound to the selected friend, and may display the device list. In addition, the discovery and sharing method may search for a list of shared services bound to the device selected in the device list and contents of shared services, and may display the list of shared services and contents of shared services.

Moreover, according to the discovery and sharing method, provisioning of the device list, the service list, or the device list and the service list that are to be shared with the selected friend and the user may be performed.

In more detail, in the Web browser, it is checked whether the selected friend is another user having a personal ID. The checking process may be realized by checking whether the person instance of the friend, which is bound to the social Web service ID of the selected friend, exists.

Next, the register instance that is bound to the person instance that includes the personal ID of the friend may be searched. In addition, a list of the device instances bound to the searched register instance may be displayed on the user terminal. Also, simultaneously or sequentially, a list of the shared service instances bound to the device instance list and contents may be generated and displayed on the user terminal.

In operation S630, the service selected from the service list is executed.

In more detail, when the user executes one service, a physical uniform resource locator (URL), through which the user may access the actual service, and service information may be output to execute the service.

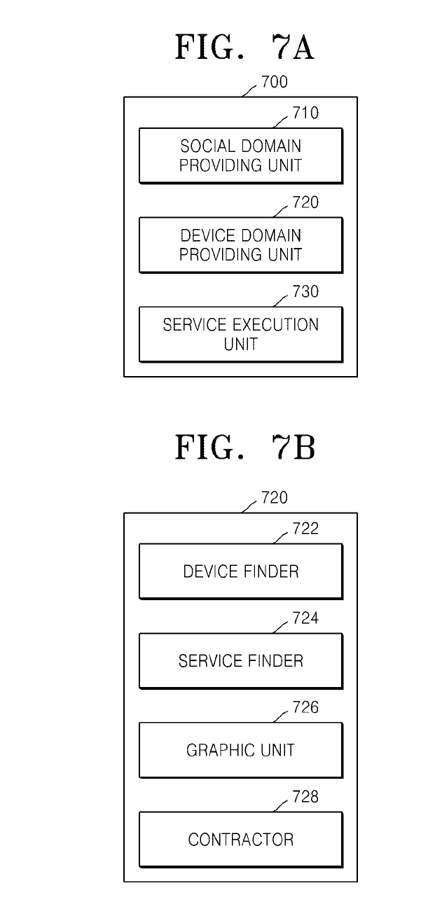

FIGS. 7A and 7B are schematic block diagrams of a discovery and sharing device 700 for realizing the system representing the user device/service as a social object based on an external social relationship, according to an exemplary embodiment. The discovery and sharing device 700 is to execute the discovery and sharing method illustrated in FIG. 6, and thus, will be described only briefly. In the discovery and sharing device 700, each of the components may be formed of an independent chip, or two or more components may be formed as a single chip.

Referring to FIG. 7A, the discovery and sharing device 700 includes a social domain providing unit 710 receiving the social information including the friend list of the user by accessing the social Web service and providing the friend list, and a device domain providing unit 720 providing the list of devices of the friend selected from the friend list and the list of services executed in the devices in the device list.

In more detail, referring to FIG. 7B, the device domain providing unit 720 includes a device finder 722 searching for the devices bound to the selected friend, a service finder 724 searching for the shared services bound to the device selected from the device list and contents of the services, and a graphic unit 726 displaying the searched list of the shared services and contents of the services.

In addition, the device domain providing unit 720 may further include a contractor 728 setting the device list, the service list, or the device list and the service list which are shared between the selected friend and the user.

According to the system representing the user device/service as the social object based on the external social relationship of the present exemplary embodiment, the following effects may be expected.

The user, the device, and data on the Web may be distinguished from each other, and thus, a new service may be created.

In addition, a technology for making the relation between person-device-data as information and distributing the information safely may be provided.

Also, the experience of sharing information with others without a spatial limitation may be provided to the users.

Also, according to the exemplary embodiment, a user-based D2D convergence environment that is human readable, intuitive, and easy to use may be provided.

Also, according to the exemplary embodiment, social commerce using social-graph-based D2D sharing may be activated.

Moreover, the system representing the user device/service as the social object based on the external social relationship according to the exemplary embodiment may be industrially applied as follows.

The exemplary embodiments may be variously applied in enlarging an open convergence ecosystem market. The open convergence ecosystem is to directly connect the user data from Web to the device by representing the device/service as the social object.

Also, the exemplary embodiments may be used in fields of sharing and advertisement services based on the social relations.

The exemplary embodiments may be used in a D2D convergence technology using a connection between a social connector and the device resource sharing.

Hereinafter, a method of representing user device/service as a social objects based on an external social relation according to an exemplary embodiment will be described in more detail.

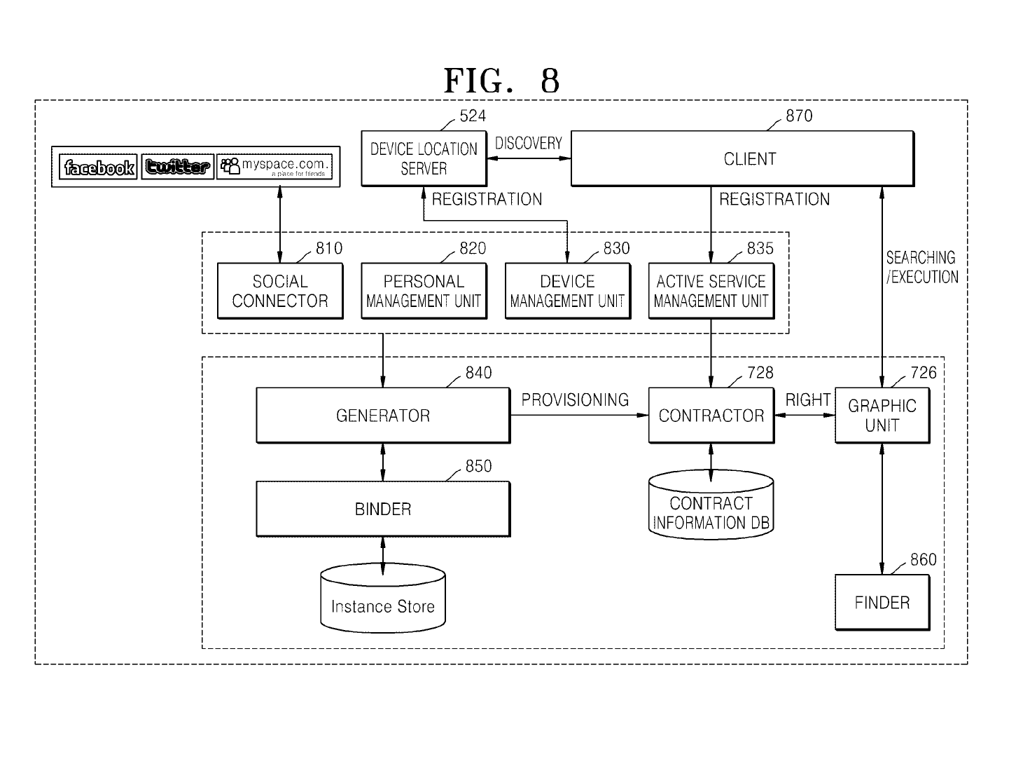

FIG. 8 is a schematic block diagram of a system that represents a user device/service as a social object based on an external social relationship according to an exemplary embodiment.

The system of FIG. 8 may execute the registration method and the discovery and sharing method for realizing the system representing the user device/service as a social object based on the external social relationship illustrated in FIGS. 3 and 6, respectively.

The system includes a social connector 810, a personal management unit 820, a device management unit 830, an active service management unit 835, a generator 840, a binder 850, a contractor 728, a finder 860, a graphic unit 726, a device location server 524, and a client 870.

The social connector 810 may receive the social Web service account information and the social information from each of the external social sites.

The personal management unit 820 may generate a user ID instance including the account information of various social Web services.

The device management unit 830 may register and manage multiple devices of the user.

The active service management unit 835 may register and manage the service or services which the user desires to share with friends.

The generator 840 generates and stores instances based on data input from the personal management unit 820, the device management unit 830, and the active service management unit 835.

The binder 850 makes the instances generated by the generator 840 to have properties and to relate to each other. That is, the binder 850 may store the instances in a linked data format.

The finder 860 searches for instances based on data input from the personal management unit 820, the device management unit 830, and the active service management unit 835. The graphic unit 726 may, according to a request of the client 870, output a result of the process performed by the finder 860 as structured data.

The device location server 524 may resolve the actual storage location of the device instance, when a device generator (not shown) in the generator 840 generates device instances in a dispersed or divided manner, and such divided instances are to be processed.

The client 870 may be a user interface connecting the user or a third party to the system. The client 870 may include a Web client or a Web browser.

As described above, each of the components may be formed of an independent chip, or two or more components may be formed as a single chip.

Therefore, the system may function as a social domain registration unit 510, the device domain registration unit 520, the social domain providing unit 710, the device domain providing unit 720, and the service execution unit 730. The finder 860 may function as the device finder 722 and the service finder 724. In addition, the binder 850 may function as the social Web service ID binder 514, the device binder 526, and the service binder 530.

On the other hand, the person registration unit 512, the device registration unit 522, and the service registration unit 528 may function as the personal management unit 820, the device management unit 830, the active service management unit 835, and the generator 840 connecting to each of the management units 820, 830, and 835.

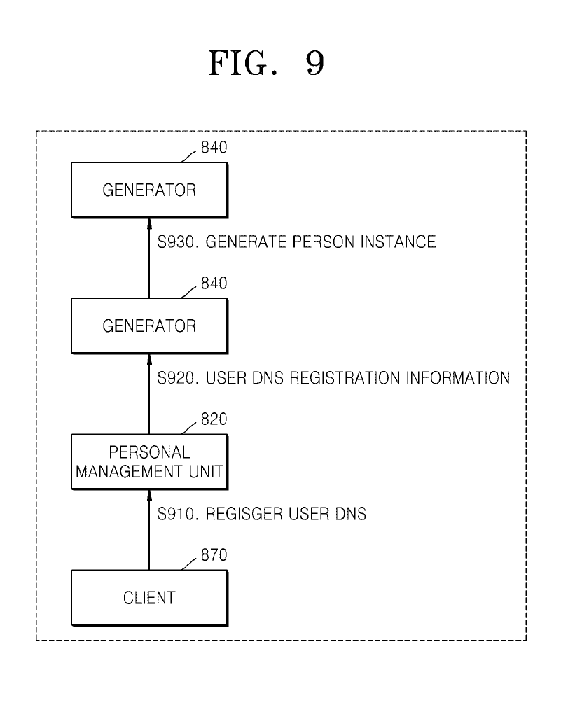

Hereinafter, various operations of the system, representing the user device/service as a social object based on an external social relationship shown in FIG. 8, will be described with reference to FIGS. 9 through 15. However, the exemplary embodiments are not limited to this exemplary order of operations.

FIG. 9 is a diagram showing a process of generating the person instance. Referring to FIG. 9, in operation S910, the personal management unit 820 generates DNS registration information of the user based on user profile information received through the client 870.

In operation S920, the personal management unit 820 transfers the DNS registration information to the generator 840.

In operation S930, the generator 840 generates the person instance of the user.

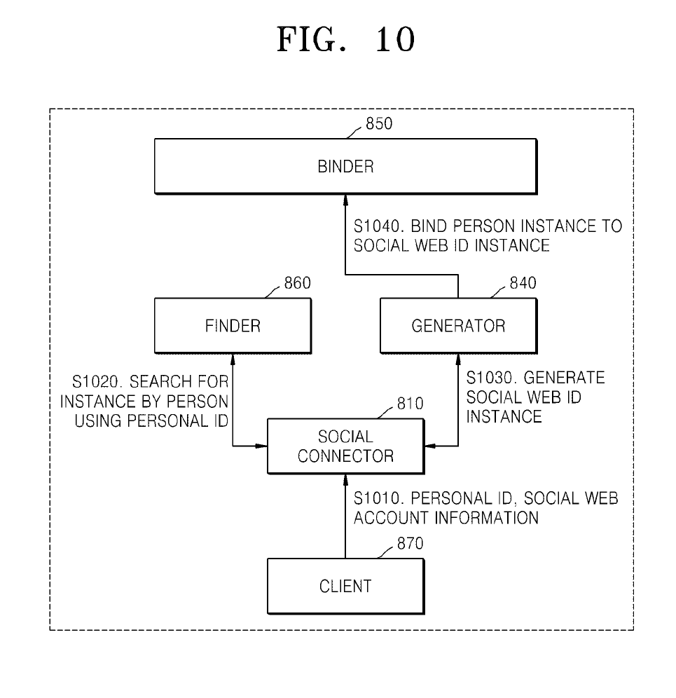

FIG. 10 is a diagram illustrating a process of generating the social Web service ID instance.

In operation S1010, the social connector 810 acquires the personal ID and the social Web service account information of the user through the client 870. In operation S1020, the finder 860 searches for the person instance by using the personal ID of the user.

In operation S1030, the generator 840 generates the social Web service ID instance by using the social Web service ID received from the social connector 810. In operation S1040, the binder 850 binds the person instance to the social Web service ID instance.

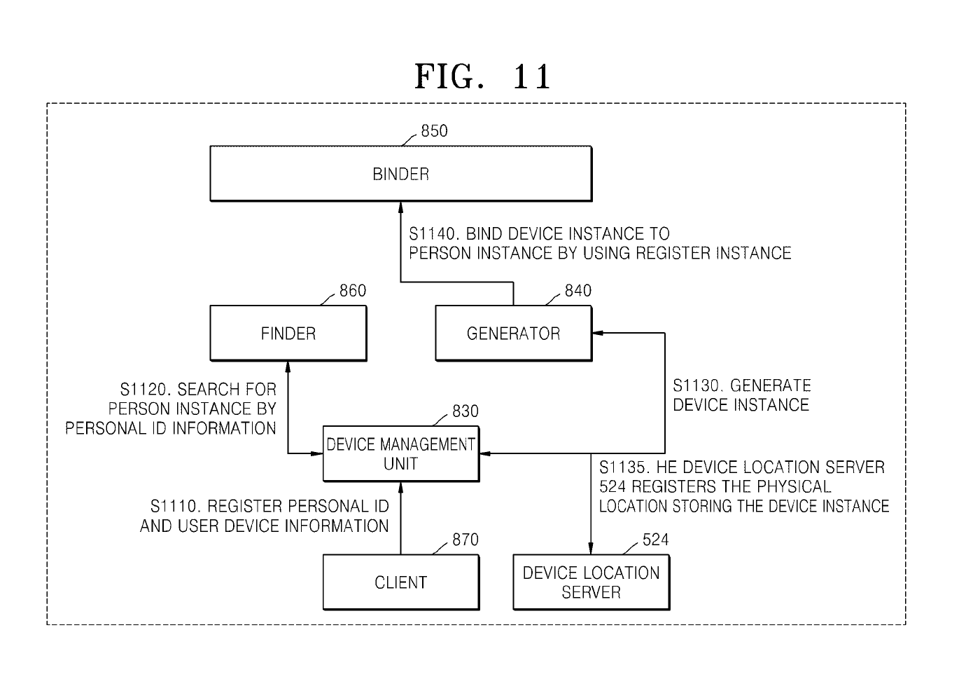

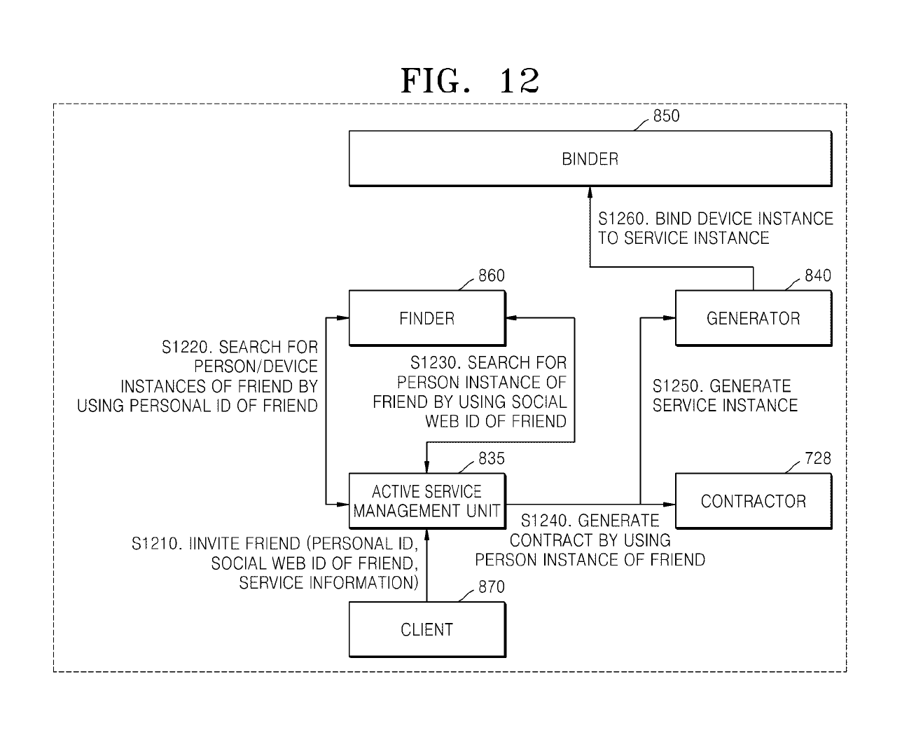

FIG. 11 is a diagram illustrating a process of generating the device instance.

In operation S1110, the device management unit 830 registers the personal ID and the device information of the user received through the client 870. In operation S1120, the finder 860 searches for the person instance of the user by using the personal ID.

In operation S1130, the generator 840 generates the device instance by using the device information registered in the device management unit 830. Here, in operation S1135, the device location server 524 registers the physical location storing the device instance, for use in the case in which the device instance is stored in a divided manner.

In operation S1140, the binder 850 binds the device instance and the person instance to each other by using the register instance.

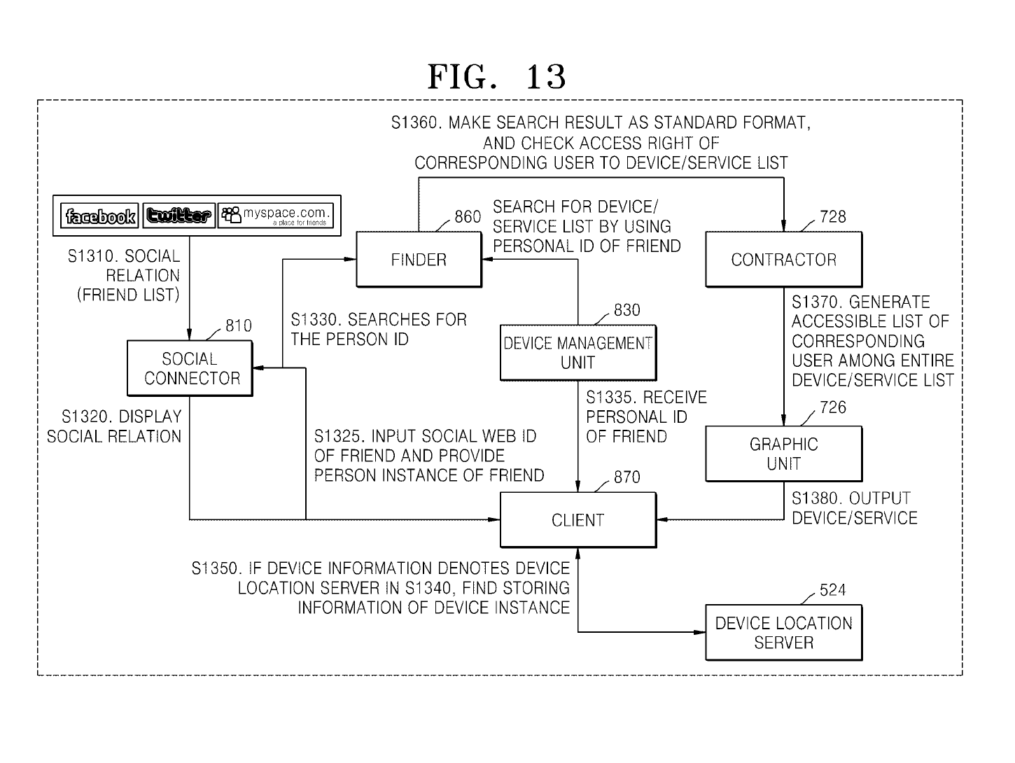

FIG. 12 is a block diagram illustrating a process of generating the active service instance.

In operation S1210, the service management unit acquires, through the client 870, invitation information relating to the friend, including the personal ID of the friend, the social Web service ID of the friend, and the service information. In operation S1220, the finder 860 searches for the person/device instances of the friend by using the personal ID of the friend.

In operation S1230, the finder 860 searches for the person instance of the friend by using the social Web service ID of the friend. In operation S1240, the contractor 728 generates a sharing contract between the friend and the user by using the person instance of the friend.

In operation S1250, the generator 840 generates the service instance. In addition, in operation S1260, the binder 850 binds the device instance and the service instance to each other.

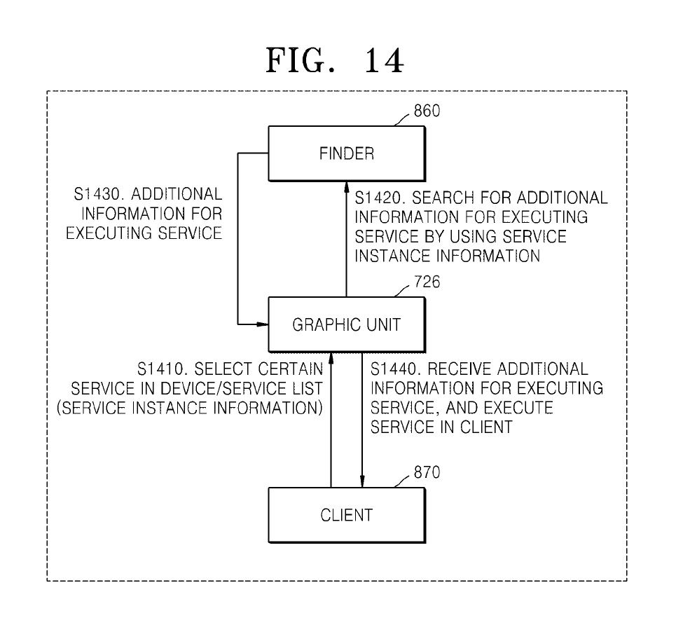

FIG. 13 is a diagram illustrating processes of discovering and sharing the user device/service list based on the external social relationship.

In operation S1310, the social connector 810 receives social information including the list of friends of the user from an external social Web service.

In addition, in operation S1320, the client 870 displays, on the user terminal, the friend list received from the social connector 810. The user selects one of the friends included in the friend list. The friend list includes the social Web service IDs of the friends. Therefore, in operation S1325, the social connector 810 transmits as the social Web service ID of the selected friend as an input into the finder 860. The finder 860 searches for the person instance of the friend by using the social Web service ID of the friend to provide the client 870 with the person instance through the social connector 810.

In operation S1330, the finder 860 searches for the person ID included in the person instance of the friend. In operation S1335, the device management unit 830 receives the personal ID of the friend through the client 870. In operation S1340, the finder 860 searches for the device/service list of the friend by using the personal ID of the friend. Here, in operation S1350, when the device information denotes the device location server 524, the finder 860 searches for the storage location of the device instance from the device location server 524.

In operation S1360, the finder 860 puts the found device/service list in a standard format, and the contractor 728 inspects the access rights of the corresponding user with respect to the device/service list.

In operation S1370, the contractor 728 generates an accessible list, related to the corresponding user, indicating which devices/services among the entire device/service list are accessible in terms of the inspected access rights which were inspected by the contractor 728 in operation S1360. In operation S1380, the graphic unit 726 outputs the device/service list to the client 870.

FIG. 14 is a diagram illustrating a process of executing the service in the client 870, following the process of FIG. 13.

Referring to FIG. 14, in operation S1410, the user selects a certain service in the device/service list output from the graphic unit 726 through the client 870. Here, when the certain service of the counterpart is selected, the active service management unit 835 searches for the service instance of the counterpart.

In operation S1420, the graphic unit 726 requests the finder 860 to search for additional information for executing the service by using the service instance information. In operation S1430, the finder 860 provides the graphic unit 726 with the additional information for executing the service.

In operation S1440, the client 870 receives the additional information for executing the service through the graphic unit 726, and executes the corresponding service.

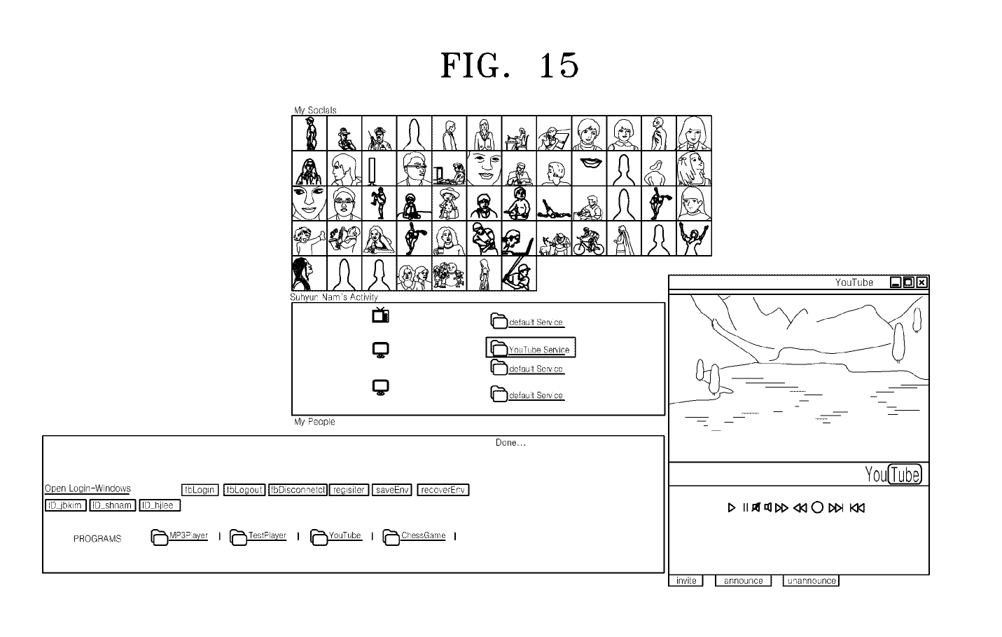

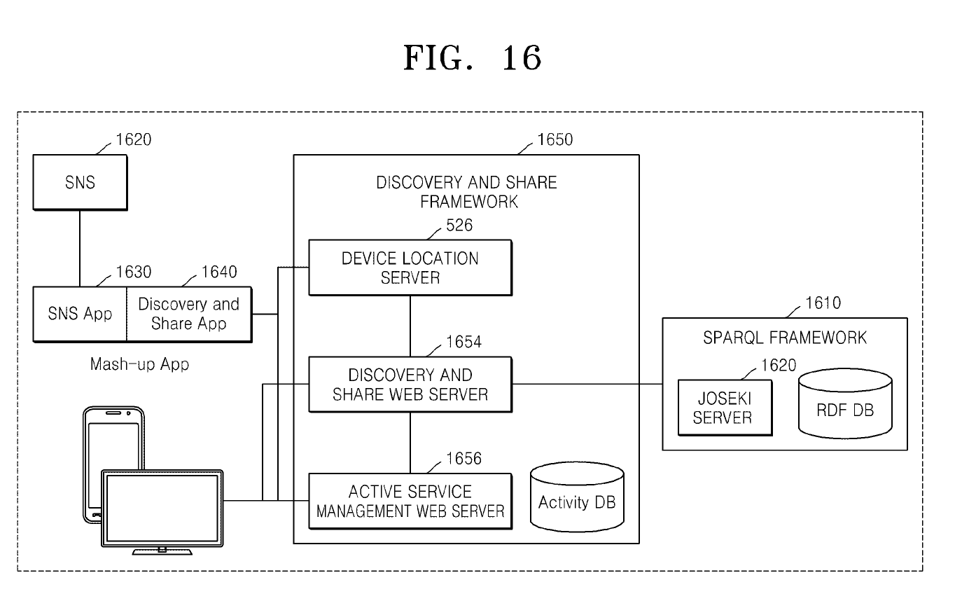

FIG. 15 is a diagram showing an example of a user interface screen (or Web browser screen) in a scenario according to an exemplary embodiment. FIG. 15 illustrates an example of the output of the discovery and sharing process for realizing a system representing a user device/service as a social object based on an external social relationship shown in FIGS. 6, 7A, 7B, 8, and 13. However, the above scenario is merely an example, and the inventive concept is not limited thereto.

The user selects FACEBOOK in a social domain (not shown) including various social Web services (for example, FACEBOOK, MYSPACE, and TWITTER, etc.) through the Web browser. Then, the social domain providing unit 710 provides the user with the friend list provided by the FACEBOOK through My Socials screen.

Then, the user selects ‘Suhyun Nam’ in the friend list. The device providing unit generates and outputs the device/service list of Suhyun Nam on Suhyun Nam's activity screen 1520.

Next, when the user selects the YOUTUBE service in the service list, the service execution unit 730 outputs the physical URL, through which the user may access the actual service, and the service information to execute the service. That is, when the user selects the YOUTUBE service, the YOUTUBE service and the contents 1530 of the YOUTUBE service shared by ‘Suhyun Nam’ are executed.

FIG. 16 is a block diagram of a system for representing a user device/service as a social object based on an external social relationship in a scenario according to an exemplary embodiment. However, the scenario is an example, and the inventive concept is not limited thereto.

Referring to FIG. 16, an RDF structure is used to represent relational information between data instances in a simple way, and to do this, a Simple Protocol And RDF Query Language (SPARQL) framework 1610 is used.

The client 870 may be realized as a kind of “mash-up” application. The mash-up type application may include an SNS application (App) 1630 acquiring the relational information from an SNS site 1620, and a discovery and sharing App 1640 for connecting to a discovery and sharing framework 1650. The discovery and sharing framework 1650 may execute the discovery and sharing processes for realizing the system for representing a user device/service as a social object based on an external social relationship, as shown in FIGS. 6, 7A, 7B, 8, and 13. However, for the convenience of description, only some of the components in the discovery and sharing framework 1650 are shown.

The discovery and sharing framework 1650 includes a device location server 524 for registering the storage locations of the device instances, when the device instances are stored in a dispersed manner, and for performing the discovery service based on the storing location of the device instance, a discovery and sharing Web server 1654 for communicating with the SPARQL framework and for searching and generating related information, and an active service management Web server 1656 managing additional data that is required to execute the service.

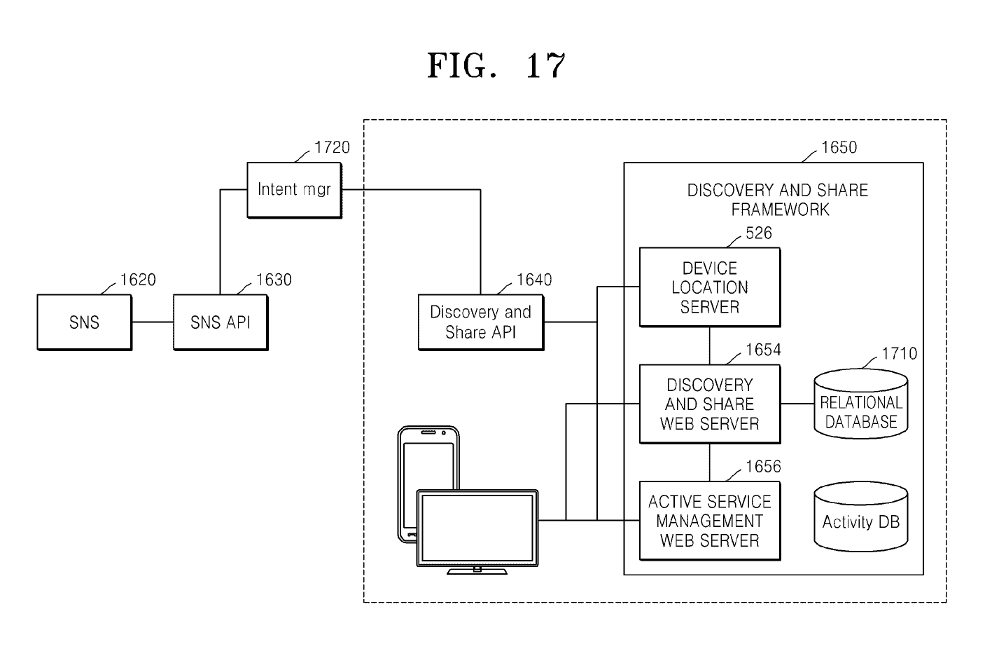

FIG. 17 is a block diagram of a system representing user device/service as a social object based on the external social relationship in a scenario according to another exemplary embodiment. The above scenario is an example, and the inventive concept is not limited thereto.

The system shown in FIG. 17 has the same structure as that of FIG. 16 except for that a relational database is used, and the client 870 uses an intent manager communicating via the API of the present exemplary embodiment to outside.

Another exemplary embodiment includes computer readable codes and/or instructions stored on a computer readable recording medium. The computer readable recording medium may be any physical data storage device that can store data which can be thereafter read by a computer system. Examples of a computer readable recording medium include a read-only memory (ROM), a random-access memory (RAM), CD-ROMs, magnetic tapes, floppy disks, and optical data storage devices. The computer readable recording medium can also be distributed over a network of coupled computer systems so that the computer readable code may be stored and executed in a distributed fashion. Also, functional programs, codes, instructions, and/or code segments for accomplishing the exemplary embodiments can, now that the above exemplary embodiments have been described, be achieved without difficulty by programmers skilled in this field.

While the inventive concept has been particularly shown and described with reference to exemplary embodiments thereof, it will be understood by those of ordinary skill in the art that various changes in form and details may be made therein without departing from the spirit and scope of the inventive concept as defined by the following claims.

What is claimed is:

1. A method of representing a user device and a service as a social object, the method comprising:
registering user information of a user;
receiving social Web service account information of the user from a social Web service, and registering the social Web service account information in relation to registered user information; and
receiving information about the user device and information about one or more services able to be executed in the user device, and registering the received information in relation to the user information.

2. The method of claim 2, wherein (1) the relating of the social Web service account information of the user and the user information of the user, and (2) the relating of the device information, the service information, and the user information, are performed by a binding information representing technology including at least one of resource description framework (RDF), extensible markup language (XML)-based metadata, and a relational database.

3. The method of claim 1, wherein:
the registering of the user information comprises generating a person instance of the user, including a personal identity (ID), based on domain name service (DNS) registration information of the user, and
the receiving of the social Web service account information of the user and the registering of the information in relation to the user information comprises:
generating a social Web service ID instance including social Web service ID of the user based on the social Web service account information; and
binding the social Web service ID instance to the person instance.

4. The method of claim 3, wherein:
the receiving of the user device information and the service information, and the registering of the information in relation to the user information, comprise:
receiving device information of the user;
generating a device instance including the device information; and
binding the person instance to the device instance by using a register instance.

5. The method of claim 4, further comprising registering a storage location of the device instance, when the device instance is stored in more than one storage location.

6. The method of claim 4, wherein the receiving of the user device information and the service information, and the registering of the information in relation to the user information, comprise:
generating a service instance including information about a service to be shared; and
binding the device instance to the service instance.

7. A method of representing a user device and a service as a social object, the method comprising:
accessing a social Web service to receive and provide social information including a list of friends of a user;
providing a list of devices of a friend selected from the friend list, and a list of services executed in the devices included in the device list; and
responding to a selection of a service in the list of services by executing the selected service.

8. The method of claim 7, wherein the providing of the list of devices of the selected friend and the list of services executed in the device comprises:
searching for instances of devices bound to an instance representing the selected friend, and displaying a list of the found devices; and
searching for instances of services and contents of the services bound to one or more devices in the list of found devices, and displaying a list of the found services and contents.

9. The method of claim 7, wherein the providing of the device list of the selected friend and the service list executed in the devices included in the device list comprises setting one or more of the device list and the service list to be shared between the selected friend and the user.

10. The method of claim 7, wherein the receiving and providing of the social information comprises:
performing a user verification based on a personal identity (ID) of the user;
checking whether the verified user has social Web service ID information;
receiving social information of the verified user and social Web service IDs of the friends included in the friend list, by accessing the social Web service; and
displaying the friend list based on the received social information.

11. The method of claim 10, wherein the providing of the device list of the selected friend and the service list executed in the devices included in the device list comprises:
checking whether the selected friend is another user having a verified personal ID based on the social Web service ID of the selected friend;
searching for a register instance that is bound to a person instance including the personal ID of the selected friend; and
generating and displaying:
a device instance list of the devices bound to the register instance,
a shared service instance list of the services bound to the device instance list and
contents of the shared service instance.

12. The method of claim 7, wherein the devices in the device list wirelessly share service contents with other devices.

13. An apparatus for representing a user device and a service as a social object, the apparatus comprising:
a social domain registration unit that registers user information, receives a social Web service account of the user from a social Web service, and registers the social Web service account in relation to the user information; and
a device domain registration unit that receives device information of the user and service information executed in the device, and that registers the device and service information in relation to the user information.

14. The apparatus of claim 13, wherein the social domain registration unit comprises:
a person registration unit that registers a person instance, including a personal identity (ID) of the user, based on domain name service (DNS) registration information of the user; and
a social Web service ID binder that generates a social Web service ID instance including a social Web service ID of the user, based on the social Web service account information, and that binds the social Web service ID instance to the person instance.

15. The apparatus of claim 14, wherein the device domain registration unit comprises:
a device registration unit that receives device information of the user, and that generates a device instance including the device information; and
a device binder that binds the person instance and the device instance to each other by way of a register instance.

16. The apparatus of claim 15, wherein the device domain registration unit comprises a device location server that registers a storage location of the device instance.

17. The apparatus of claim 15, wherein the device domain registration unit comprises:
a service registration unit that generates a service instance including information about a service to be shared; and
a service binder that binds the device instance and the service instance to each other.

18. An apparatus for representing a user device and a service as a social object, the apparatus comprising:
a social domain providing unit that receives and provides social information, including a list of friends of a user, by accessing a social Web service;
a device domain providing unit that provides a list of devices of a friend selected from the list of friends, and a list of services executed in the devices included in the list of devices of the friend; and
a service execution unit that executes a service selected from the service list.

19. The apparatus of claim 18, wherein the device domain providing unit comprises:
a device finder that searches for devices bound to the friend selected in the friend list, and generates the list of devices;
a service finder that searches for shared services bound to a device selected in the device list and contents of the shared services, and generates the list of shared services executed; and
a graphic unit that displays the list of devices, the list of shared services and the contents of the shared service.

20. A computer program product, comprising:
a physical computer-readable medium; and
computer program instructions stored on the computer-readable medium;
the computer program instructions defining a class library with instances comprising:
a person instance representing an identity of a given person;
a device instance representing a given device;
a social web identity instance representing a given social Web service account of the given person, wherein the person instance also represents a binding between the given person and the social web service identity instance;
a service instance representing a social Web service, of the given person, to be shared, wherein the device instance also represents a binding between the given device and the social Web service to be shared; and
a register instance representing a binding between the person instance and the device instance;
wherein the computer program instructions also enable a computer system to generate and store the instances.
